(19) United States
(12) Patent Application Publication
(10) Pub. No.: US 2024/0235755 A9
(43) Pub. Date: Jul. 11, 2024

(54) SUB-MIB TRANSMISSION SCHEMES

(71) Applicant: ZTE Corporation, Shenzhen (CN)

(72) Inventors: Youjun HU, Shenzhen (CN); Bo DAI, Shenzhen (CN); Luanjian BIAN, Shenzhen (CN); Huiying FANG, Shenzhen (CN); Kun LIU, Shenzhen (CN)

(73) Assignee: ZTE Corporation, Shenzhen (CN)

(21) Appl. No.: 18/380,943

(22) Filed: Oct. 17, 2023

Related U.S. Application Data
(63) Continuation of application No. PCT/CN2021/098002, filed on Jun. 2, 2021.

(51) Int. Cl. H04L 5/00

(52) U.S. Cl. CPC H04L 5/0046; H04L 5/0048; H04L 5/0098

(57) ABSTRACT

A wireless communication system includes a plurality of communication nodes. A first communication node may determine transmit a master information block (MIB), where the MIB comprises a plurality of sub-MIBs. The first communication node transmits the plurality of sub-MIBs to one or more second communication nodes. A second communication node receives the plurality of sub-MIBs and detects the plurality of sub-MIBs. In various embodiments, the plurality of sub-MIBs includes a common sub-MIB common to different types of communication nodes, and a specific sub-MIB specific to a particular type of communication node.

### TECHNICAL FIELD

This document is directed generally to wireless communications, and more particularly to sub-master information block transmission schemes.

### BACKGROUND

For existing communication systems, including New Radio (NR) systems, if internet-of-things (IoT) devices need to access a network, a separate radio access technology (RAT) is designed due to narrow bandwidth constraints. Such new RAT designs bring efficiency loss, system complexity, and increased and wasted resources, since another RAT for NR user equipment (UE) devices is being introduced into the systems. To avoid these undesirable effects, ways for future generations of wireless communication systems to have unified designs, including those for initial access procedures, for different UEs, RATs, applications, scenarios, and/or use cases may be desirable.

### SUMMARY

This document relates to methods, systems, apparatuses for communicating a plurality of sub-MIBs. In some implementations, a method for wireless communication is disclosed. The method may include: determining, with a first communication node, a master information block (MIB) to transmit to a second communication node, wherein the MIB comprises a plurality of sub-MIBs; and transmitting, with the first communication node, the plurality of sub-MIBs to the second communication node.

In some other implementations, a method for wireless communication is disclosed. The method may include: receiving, with a second communication node, a master information block (MIB) from a first communication node, the MIB comprising a plurality of sub-MIBs; and detecting, with the second communication node, the plurality of sub-MIBs upon receiving the plurality of sub-MIBs.

In some other implementations, a system including one or more network devices is disclosed. The one or more network devices may include one or more processors and one or more memories, wherein the one or more processors are configured to read computer code from the one or more memories to implement any one of the methods above.

In yet some other implementations, a computer program product is disclosed. The computer program product may include a non-transitory computer-readable program medium with computer code stored thereupon, the computer code, when executed by one or more processors, causes the one or more processors to implement any one of the methods above.

The above and other aspects and their implementations are described in greater detail in the drawings, the descriptions, and the claims.

### BRIEF DESCRIPTION OF THE DRAWINGS

FIG. 1 shows a block diagram of an example of a wireless communication system.

FIG. 2 show a schematic diagram of an example time/frequency structure of a synchronization signal block.

FIG. 3A shows a flow chart of an example method for wireless communication.

FIG. 3B shows a flow chart of another example method for wireless communication.

FIG. 4 shows a schematic diagram of a first example time/frequency structure for communication of a plurality of sub-master information blocks (sub-MIBs).

FIG. 5 shows a schematic diagram of a second example time/frequency structure for communication of a plurality of sub-MIBs.

FIG. 6 shows a schematic diagram of a third example time/frequency structure for communication of a plurality of sub-MIBs.

FIG. 7 shows a schematic diagram of a fourth example time/frequency structure for communication of a plurality of sub-MIBs.

FIG. 8 shows a schematic diagram of a fifth example time/frequency structure for communication of a plurality of sub-MIBs.

FIG. 9 shows a schematic diagram of a sixth example time/frequency structure for communication of a plurality of sub-MIBs.

FIG. 10 shows a schematic diagram of a seventh example time/frequency structure for communication of a plurality of sub-MIBs.

FIG. 11 shows a schematic diagram of a eighth example time/frequency structure for communication of a plurality of sub-MIBs.

FIG. 12 shows a schematic diagram of a ninth example time/frequency structure for communication of a plurality of sub-MIBs.

FIG. 13 shows a schematic diagram of a tenth example time/frequency structure for communication of a plurality of sub-MIBs.

FIG. 14 shows a schematic diagram of a eleventh example time/frequency structure for communication of a plurality of sub-MIBs.

FIG. 15 shows a schematic diagram of a twelfth example time/frequency structure for communication of a plurality of sub-MIBs.

FIG. 16 shows a schematic diagram of a thirteenth example time/frequency structure for communication of a plurality of sub-MIBs.

FIG. 17 shows a schematic diagram of a fourteenth example time/frequency structure for communication of a plurality of sub-MIBs.

FIG. 18 shows a schematic diagram of a fifteenth example time/frequency structure for communication of a plurality of sub-MIBs.

FIG. 19 shows a schematic diagram of a sixteenth example time/frequency structure for communication of a plurality of sub-MIBs.

FIG. 20 shows a schematic diagram of a seventeenth example time/frequency structure for communication of a plurality of sub-MIBs.

FIG. 21 shows a schematic diagram of a eighteenth example time/frequency structure for communication of a plurality of sub-MIBs.

FIG. 22 shows a schematic diagram of a nineteenth example time/frequency structure for communication of a plurality of sub-MIBs.

FIG. 23 shows a schematic diagram of a twentieth example time/frequency structure for communication of a plurality of sub-MIBs.

FIG. 24 shows a schematic diagram of a twenty-first example time/frequency structure for communication of a plurality of sub-MIBs.

FIG. 25 shows a schematic diagram of a twenty-second example time/frequency structure for communication of a plurality of sub-MIBs.

FIG. 26 shows a schematic diagram of a twenty-third example time/frequency structure for communication of a plurality of sub-MIBs.

FIG. 27 shows a schematic diagram of a twenty-fourth example time/frequency structure for communication of a plurality of sub-MIBs.

FIG. 28 shows a schematic diagram of a twenty-fifth example time/frequency structure for communication of a plurality of sub-MIBs.

FIG. 29 shows a schematic diagram of a twenty-sixth example time/frequency structure for communication of a plurality of sub-MIBs.

FIG. 30 shows a schematic diagram of a twenty-seventh example time/frequency structure for communication of a plurality of sub-MIBs.

FIG. 31 shows a schematic diagram of a twenty-eighth example time/frequency structure for communication of a plurality of sub-MIBs.

FIG. 32 shows a schematic diagram of a twenty-ninth example time/frequency structure for communication of a plurality of sub-MIBs.

FIG. 33 shows a schematic diagram of a thirtieth example time/frequency structure for communication of a plurality of sub-MIBs.

FIG. 34 shows a schematic diagram of a thirty-first example time/frequency structure for communication of a plurality of sub-MIBs.

FIG. 35 shows a schematic diagram of a thirty-second example time/frequency structure for communication of a plurality of sub-MIBs.

FIG. 36 shows a schematic diagram of a thirty-third example time/frequency structure for communication of a plurality of sub-MIBs.

FIG. 37 shows a schematic diagram of a thirty-fourth example time/frequency structure for communication of a plurality of sub-MIBs.

FIG. 38 shows a schematic diagram of a thirty-fifth example time/frequency structure for communication of a plurality of sub-MIBs.

FIG. 39 shows a schematic diagram of a thirty-sixth example time/frequency structure for communication of a plurality of sub-MIBs.

FIG. 40 shows a schematic diagram of a thirty-seventh example time/frequency structure for communication of a plurality of sub-MIBs.

FIG. 41 shows a schematic diagram of a thirty-eighth example time/frequency structure for communication of a plurality of sub-MIBs.

FIG. 42 shows a schematic diagram of a thirty-ninth example time/frequency structure for communication of a plurality of sub-MIBs.

FIG. 43 shows a schematic diagram of a fortieth example time/frequency structure for communication of a plurality of sub-MIBs.

FIG. 44 shows a schematic diagram of a forty-first example time/frequency structure for communication of a plurality of sub-MIBs.

FIG. 45 shows a schematic diagram of a forty-second example time/frequency structure for communication of a plurality of sub-MIBs.

FIG. 46 shows a schematic diagram of a forty-third example time/frequency structure for communication of a plurality of sub-MIBs.

FIG. 47 shows a schematic diagram of a forty-fourth example time/frequency structure for communication of a plurality of sub-MIBs.

FIG. 48 shows a schematic diagram of a forty-fifth example time/frequency structure for communication of a plurality of sub-MIBs.

FIG. 49 shows a schematic diagram of a forty-sixth example time/frequency structure for communication of a plurality of sub-MIBs.

FIG. 50 shows a schematic diagram of a forty-seventh example time/frequency structure for communication of a plurality of sub-MIBs.

FIG. 51 shows a schematic diagram of a forty-eighth example time/frequency structure for communication of a plurality of sub-MIBs.

FIG. 52 shows a schematic diagram of a forty-ninth example time/frequency structure for communication of a plurality of sub-MIBs.

FIG. 53 shows a schematic diagram of a fiftieth example time/frequency structure for communication of a plurality of sub-MIBs.

FIG. 54 shows a schematic diagram of a fifty-first example time/frequency structure for communication of a plurality of sub-MIBs.

FIG. 55 shows a schematic diagram of a fifth-second example time/frequency structure for communication of a plurality of sub-MIBs.

### DETAILED DESCRIPTION

The present description describes wireless communications involving transmission of a plurality of sub-MIBs. The plurality of sub-MIBs may be transmitted according to transmission schemes allocating resource sets that overlap and/or not overlap in the time domain and the frequency domain in any of various ways or combinations. One or more of the sub-MIBs may be configured as a common sub-MIB that is common for receiving nodes of any of various types, and one or more of the sub-MIBs may be configured as a specific sub-MIB that is specific for a specific type of receiving node. Through use of the sub-MIBs, a wireless communication system may employ a unified way of transmitting system information for different types of communication nodes (e.g., user equipment devices). This, in turn, may minimize or reduce efficiency loss, system complexity, and/or an amount of increased and wasted resources that may otherwise be created for devices of different types gaining access to a wireless communication system. These and other technical improvements, advantages, and benefits will become apparent in view of the further detailed description and the accompanying drawings.

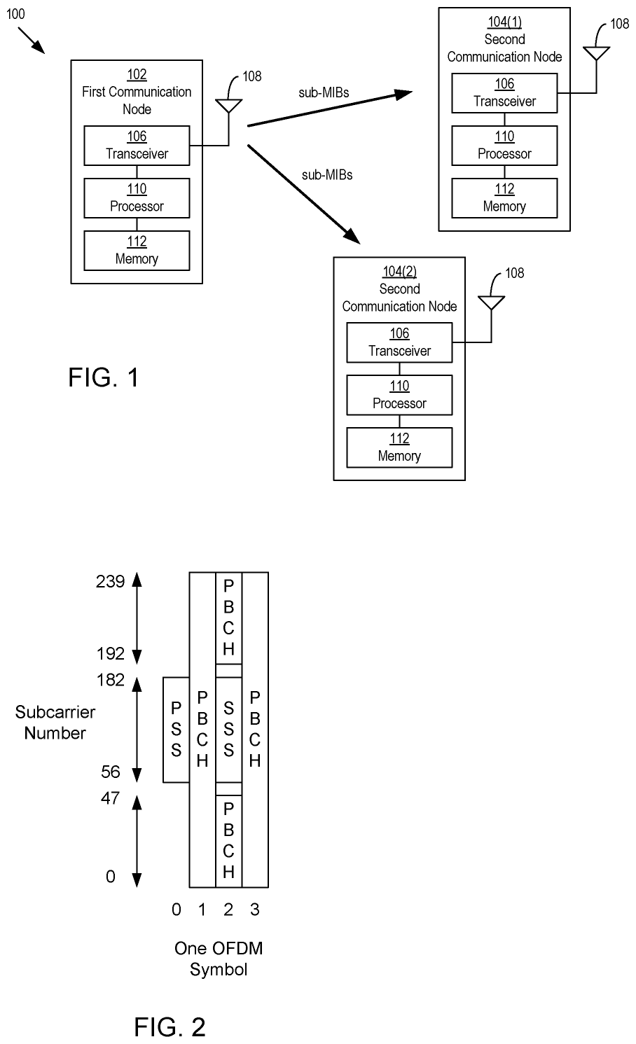

FIG. 1 shows a diagram of an example wireless communication system 100 including a plurality of communication nodes that are configured to wirelessly communicate with each other. The communication nodes includes a first communication node 102 and one or more second communication nodes 104. The system 100 in FIG. 1 shows two second communication nodes 104(1), 104(2). In other embodiments, the system 100 may include only one second communication node or more than two second communication nodes.

In general, each communication node is an electronic device, or a plurality (or network or combination) of electronic devices, that is configured to wirelessly communicate with another node in the wireless communication system, including wirelessly transmitting and receiving signals. In various embodiments, each communication node may be one of a plurality of types of communication nodes.

One type of communication node is a user device. A user device may include a single electronic device or apparatus, or multiple (e.g., a network of) electronic devices or apparatuses, capable of communicating wirelessly over a network. A user device may include or otherwise be referred to as a user terminal or a user equipment (UE). Additionally, a user device may be or include, but not limited to, a mobile device (such as a mobile phone, a smart phone, a tablet, or a laptop computer, as non-limiting examples) or a fixed or stationary device, (such as a desktop computer or other computing devices that are not ordinarily moved for long periods of time, such as appliances, other relatively heavy devices including Internet of things (IoT), or computing devices used in commercial or industrial environments, as non-limiting examples).

A second type of communication node is a wireless access node. A wireless access node may comprise one or more base stations or other wireless network access points capable of communicating wirelessly over a network with one or more user devices and/or with one or more other wireless access nodes. For example, the wireless access node 104 may comprise a 4G LTE base station, a 5G NR base station, a 5G central-unit base station, a 5G distributed-unit base station, a next generation Node B (gNB), an enhanced Node B (eNB), or other base station, or network in various embodiments.

As shown in FIG. 1, each communication node 102, 104 may include transceiver circuitry 106 coupled to an antenna 108 to effect wireless communication. The transceiver circuitry 106 may also be coupled to a processor 110, which may also be coupled to a memory 112 or other storage device. The processor 110 may be configured in hardware (e.g., digital logic circuitry, field programmable gate arrays (FPGA), application specific integrated circuits (ASIC), or the like), and/or a combination of hardware and software (e.g., hardware circuitry (such as a central processing unit (CPU)) configured to execute computer code in the form of software and/or firmware to carry out functions). The memory 112, which may be in the form of volatile memory, non-volatile memory, combinations thereof, or other types of memory, may be implemented in hardware, and may store therein instructions or code that, when read and executed by the processor 110, cause the processor 110 to implement various functions and/or methods described herein. Also, in various embodiments, the antenna 108 may include a plurality of antenna elements that may each have an associated phase and/or amplitude that can be controlled and/or adjusted, such as by the processor 110. Through this control, a communication node may be configured to have transmit-side directivity and/or receive-side directivity, in that the processor 110, and/or the transceiver circuitry 106, can perform beam forming by selecting a beam from among a plurality of possible beams, and transmit or receive a signal with the antenna radiating the selected beam.

Additionally, in various embodiments, the communication nodes 102, 104 may be configured to wirelessly communicate with each other in or over a mobile network and/or a wireless access network according to one or more standards and/or specifications. In general, the standards and/or specifications may define the rules or procedures under which communication nodes 102, 104 can wirelessly communicate, which may include those for communicating in millimeter (mm)-Wave bands, and/or with multi-antenna schemes and beamforming functions. In addition or alternatively, the standards and/or specifications are those that define a radio access technology and/or a cellular technology, such as Fourth Generation (4G) Long Term Evolution (LTE), Fifth Generation (5G) New Radio (NR), or New Radio Unlicensed (NR-U), as non-limiting examples.

In the wireless system 100, the communication nodes 102, 104 are configured to wirelessly communicate signals between each other. In general, a communication in the wireless system 100 between two communication nodes can be or include a transmission or a reception, and is generally both simultaneously, depending on the perspective of a particular node in the communication. For example, for a given communication between the first node 102 and the second node 104 where the first node 102 is transmitting a signal to the second node 104 and the second node 104 is receiving the signal from the first node 102, the first node 102 may be referred to as a sending or transmitting node (or a sending or transmitting device), the second node 104 may be referred to as a receiving node or (a receiving device), and the communication may be considered a transmission for the first node and a reception for the second node. Of course, since communication nodes in a wireless system 100 can both send and receive signals, a single communication node may be both a sending node/device and a receiving node/device simultaneously or switch between being a sending node/device and a receiving node/device.

In various embodiments of the system 100, including those implementing NR, to enable one or more of the nodes 102, 104 to find a cell when entering the system 100, as well as to find new cells when moving within the system, the first node 102, which may be configured as a wireless access node, may transmit a synchronization signal as a downlink to one or more of the second nodes 104, which may be configured as UE devices for at least some embodiments. A synchronization signal may include two parts, including a primary synchronization signal (PSS) and a secondary synchronization signal (SSS). The first node 102 may periodically transmit the synchronization signal to the second nodes 104. The PSS and SSS, in combination with a physical broadcast channel (PBCH), may be referred to as a synchronization signal block (SSB or SS Block).

The first node 102 may transmit the SSB on a set of time/frequency resources or resource elements. FIG. 2 shows a schematic diagram of an example time/frequency structure or design (which may also be referred to as an orthogonal frequency-division multiplexing (OFDM) grid) of a SS Block. Further Table 1, below, identifies resources within a SS Block and a demodulation reference signal (DM-RS) for PBCH.

TABLE 1
Resources within a SS Block and a DM-RS for PBCH

| | OFDM symbol number l | Subcarrier number k |
|---|---|---|
| Channel | relative to the start of an | relative to the start of an |
| or signal | SS/PBCH block | SS/PBCH block |
| PSS | 0 | 56, 57, . . . , 182 |
| SSS | 2 | 56, 57, . . . , 182 |
| Set to 0 | 0 | 0, 1, . . . , 55, 183, 184, . . . , 239 |
| | 2 | 48, 49, . . . , 55, 183, 184, . . . , |
| | | 191 |
| PBCH | 1, 3 | 0, 1, . . . , 239 |
| | 2 | 0, 1, . . . , 47, |
| | | 192, 193, . . . , 239 |
| DM-RS | 1, 3 | 0 + v, 4 + v, 8 + v, . . . , 236 + v |
| for PBCH | 2 | 0 + v, 4 + v, 8 + v, . . . , 44 + v |
| | | 192 + v, 196 + v, . . . , 236 + v |

The PBCH carries part of the system information that a communication node (e.g., a UE) needs to be able to communicate in the system 100. As shown in FIG. 2, the PBCH is transmitted within the second and fourth OFDM symbols of the SS Block. Further, when a communication node enters a connected state, the communication node has obtained information from the PBCH about a control resource set (CORSET), where the communication node can find the control channel used to schedule the remaining system information.

Additionally, the PBCH may carry a master information block (MIB), which contains information that a communication node identifies in order to be able to acquire remaining system information broadcast in the system 100, such as by a transmitting node or a wireless access node. For example, the first communication node 102, configured as a wireless access node, may transmit a SS Block including a PBCH that is carrying a MIB, which one or more of the second communication nodes 104 may receive in order to able to acquire remaining system information broadcast by the first communication node 102 or another node in the system 100.

For at least some embodiments, information forming, or included in, a MIB may include at least one of: a system frame number defining different transmission cycles have a period longer than one frame; sub-carrier spacing information, ssb-Subcarrier offset information identifying a frequency domain offset between the SSB and the overall resource block grid in number of subcarrier; DMRS-TypeA-position information indicating a position of a first downlink DM-RS; pdcch-ConfigSIB1 information indicating a bandwidth for a physical downlink control channel (PDCCH) and/or a system information block (SIB), a common CORESET, a common search space, and/or PDCCH parameters; cell barred information (e.g., a cellBarred flag) indicating whether or not devices are allowed to access a cell and/or whether or not access is permitted to other cells on the same frequency; or intraFreqReselection information indicating whether a UE is permitted to select another cell on a same frequency if reselection criteria are fulfilled and/or whether a UE cannot re-select a cell on the same frequency as a barred cell. Various addition or other information may be included in a MIB, which may depend on a communication standard or protocol being implemented in the system 100.

Additionally, in various embodiments, for narrow-band internet-of-things (NB-IoT) RATs, the bandwidth of a NB-IoT UE is 1 resource block (RB). Also, the bandwidth for NR SSB is 12 resource blocks (RBs). As a consequence of this mismatch in RB number, an individual or particular RAT design may be needed for a particular NB-IoT technology in order for a NB-IoT device communicating according to that particular NB-IoT technology to be able to access a NR network, such as one being used in the wireless communication system 100. This, in turn, may undesirably create efficiency loss, system complexity, and increased and wasted resources.

The present description describes various embodiments of communicating a MIB in the form of a plurality of (at least two) sub-MIBs. The plurality of sub-MIBs may be configured to allow for a unified way of communicating system information that a device may need to gain access to a wireless communication system, such as one configured for NR, or information that is otherwise included as part of a MIB. The various embodiments of the unified way may allow a transmitting node to transmit system information to a receiving node in a common way, irrespective or independent of a type of the receiving node, and/or in a common way to multiple receiving nodes of different types. A type of a receiving node (e.g., a UE) may be identified by any of various characteristics, including a particular type of RAT according to which the receiving node communicates, a bandwidth range, a number of antennas, a UE frequency point, a UE capabilities set, or any of various combinations thereof, as non-limiting examples. Receiving nodes (e.g., UEs) of different types may have one or more characteristics that are different from each other, such as different RATs, different bandwidth ranges, different numbers of antennas, different UE frequency points, or different UE capabilities sets, as examples. Through use of a plurality of sub-MIBs to communicate system information, the wireless communication system 100 may have a unified or common way of transmitting system information to receiving nodes of different types, which in turn may avoid, minimize, or reduce the undesirable effects of efficiency loss, system complexity, and/or increased and wasted resources that would otherwise be experienced.

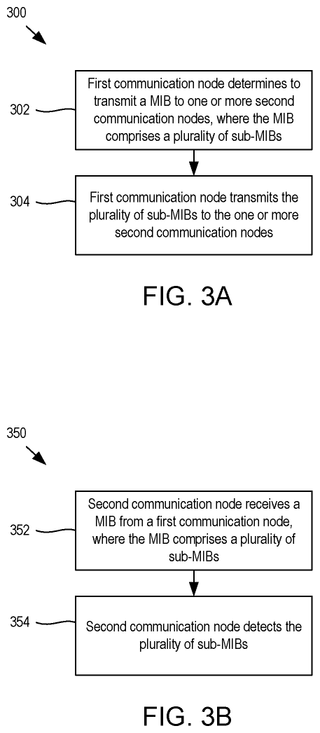

FIG. 3A shows a flow chart of an example method 300 for wireless communication that includes transmitting a plurality of sub-MIBs. As used herein, a sub-MIB is a part or a portion of a MIB that includes information that is less than an entire or a whole set of information included in a single MIB. Accordingly, for a given configuration, a certain number (one, two or more) of sub-MIBs may contain a complete set of information of a single MIB. Additionally, the example method 300 is described herein as being performed by the first communication node 102, which functions as a transmitting node and transmits the plurality of sub-MIBs to one or more of the second communication nodes 104.

Further, for at least some embodiments, the plurality of sub-MIBs of a MIB may include a common sub-MIB and one or more specific sub-MIBs. A common sub-MIB is a part or portion of a MIB that includes information, such as system information, that is common to a plurality of different types of receiving nodes (e.g., UEs). Accordingly, when transmitting a common sub-MIB, the first communication node 102 may include the information in the common sub-MIB irrespective of a type of the second communication node 104 receiving the common sub-MIB, and/or the information included in the common sub-MIB may be the same or common for different communication nodes 104 of different types. Additionally, a specific sub-MIB includes information, including system information, that is specific or particular for a specific or particular type of receiving node (e.g, UE). Accordingly, the information that the first communication node 102 includes in a specific sub-MIB may depend on the type of receiving node receiving the specific sub-MIB, and/or the first communication node 102 may include different information in different specific sub-MIBs for different types of second communication nodes 104.

At block 302, the first communication node 102 may determine a MIB to transmit to one or more second communication nodes 104. The MIB may include a plurality of sub-MIBs. For at least some embodiments, the plurality of sub-MIBs includes at least one common sub-MIB and at least one sub-MIB. Additionally, the number of sub-MIBs, including the number of common sub-MIBs and/or the number of sub-MIBs may depend on the number of second communication nodes 104 and/or the numbers of different types of second communication nodes 104. For example, for some embodiments where the first communication node 102 is to transmit the plurality of sub-MIBs to only one second communication node 104 of a particular type or to a plurality of second communication nodes 104 all of the same particular type, the first communication node 102 may determine to transmit one common sub-MIB and a one specific sub-MIB for the particular type of the one or more second communication nodes 104. In other embodiments where the first communication node 102 is to transmit to only one second communication node 104 or to a plurality of second communication nodes 104 of the same particular type, the first communication node 102 may determine to transmit one common sub-MIB and a plurality of specific sub-MIBs for the particular type of the one or more second communication nodes.

As another example, for some embodiments where the first communication node 102 is to transmit the plurality of sub-MIBs to multiple second communication nodes 104 of different types, the first communication node 102 may determine to transmit a plurality of common sub-MIBs, where a number of common sub-MIBs corresponds to the number of second communication nodes 104 and/or the number of different types of the second communication nodes 104. In addition, the first communication node 102 may determine to transmit a plurality of specific sub-MIBs, where each specific sub-MIB is for a different one of the different types of second communication nodes 104, and/or a number of the specific sub-MIBs corresponds to the number of common sub-MIBs. In other embodiments where the first communication node 102 is to transmit to a plurality of second communication nodes 104 of different types, the first communication node 102 may determine to transmit only one common sub-MIB and a plurality of specific sub-MIBs, where each specific sub-MIB is for a different one of the different types of second communication nodes 104, and/or a number of the specific sub-MIBs corresponds to the number of different types of second communication nodes 104.

Additionally, for at least some embodiments, at block 302, the first communication node 102 may separate or divide the MIB into the plurality of sub-MIBs. For example, the first communication node 102 may determine a complete set of information to include in a MIB, and may separate or divide the complete set of information into a plurality of parts or portions, where each part or portion corresponds to or is designated for a respective one of the plurality of sub-MIBs.

Also, in various embodiments, the first communication node 102 may separate or divide a MIB into the plurality of sub-MIBs depending on any of various criteria, such as initial system information, access information, idle and connected modes, synchronization information, RATs, or UE types. In some example embodiments, the first communication node 102 may include system frame number (SFN) information in a common sub-MIB. For at least some of these embodiments, the information included in the specific sub-MIBs may depend on the RAT, UE type, or other information associated with a particular type of the second communication node 104.

At block 304, the first communication node 102 may transmit the plurality of sub-MIBs to the one or more second communication nodes 104. In various embodiments, the first communication node 102 may transmit the plurality of sub-MIBs according to a transmission scheme or pattern that identifies a time domain configuration and/or a frequency domain configuration for transmission of the plurality of sub-MIBs. For example, in order to transmit the plurality of sub-MIBs, the first communication node 102 may map bits of the information included in the plurality of sub-MIBs onto resource elements, with the resource elements each corresponding to frequency domain resources and time domain resources. In various embodiments, frequency domain resources are identified by subcarrier spacing and numbers, and time domain resources are identified by symbol numbers (e.g, OFDM symbol numbers) or slot numbers.

In accordance with the mapping, the information to be transmitted may have corresponding resource sets positioned in the time domain and the frequency domain. In general, a resource set is a set of resources or resource elements for transmitting information in the time domain and the frequency domain according to which the information is wireless communicated between two communication nodes in the wireless communication system 100. In various embodiments, the information transmitted is or includes control information and/or system information, which comprises a sub-MIB. Correspondingly, each sub-MIB may have an associated resource set mapped to and/or positioned in the time domain and the frequency domain. In addition, for at least some embodiments, such as in accordance with any of various standards or protocols for wireless communication, a resource set or resource may otherwise or additionally be referred to as a physical resource set or physical resource.

Additionally, the first communication node 102 may determine a transmission scheme or pattern for the plurality of sub-MIBs such that the plurality of sub-MIBs and/or their corresponding resource sets overlap and/or do not overlap each other in the time domain and the frequency domain in any of various ways or combinations. In general, two sub-MIBs and/or two resource sets overlap in the frequency domain if they are mapped to a same frequency (e.g., a same frequency location). Conversely, two sub-MIBs and/or two resource sets do not overlap in the frequency domain if they are mapped to different frequency domain resources (e.g., different frequency locations). Similarly, two sub-MIBs and/or two resource sets overlap in the time domain if they are mapped to the same time domain resource (e.g., the same symbols, slots, frames, or subframes). Conversely, two sub-MIBs and/or two resource sets do not overlap in the time domain if they are mapped to different time domain resources (e.g, different symbols, slots, frames, or subframes).

Further, as specifically used herein, two sub-MIBs and/or two resource sets are considered to overlap in the frequency domain if they at least partially overlap in the frequency domain—e.g., if they are mapped to at least one frequency or frequency location that is the same. Conversely, two sub-MIBs and/or two resource sets are considered to not overlap in the frequency domain if they completely do not overlap in the frequency domain—e.g, if they are mapped to no frequencies or frequency locations that are the same as each other. Similarly, two sub-MIBs and/or two resource sets are considered to overlap in the time domain if they at least partially overlap in the time domain—e.g., they are mapped to at least one time domain resource that is the same. Conversely, two sub-MIBs and/or two resource sets are considered to not overlap in the time domain if none of the time domain resources to which they are mapped are the same.

Accordingly, at block 304, the first communication node 102 may transmit the plurality of sub-MIBs according to any of various ways to overlapping and non-overlapping schemes in the time domain and the frequency domain. For example, in various embodiments, the first communication node 102 may transmit the plurality of sub-MIBs such that at least two of the sub-MIBs do not overlap each other in the time domain and overlap each other in the frequency domain. In other embodiments, the first communication node 102 may transmit the plurality of sub-MIBs such that at least two of the sub-MIBs overlap each other in the time domain and do not overlap each other in the frequency domain. In still other embodiments, the first communication node 102 may transmit the plurality of sub-MIBs such that at least two of the sub-MIBs do not overlap each other in the time domain and do not overlap each other in the frequency domain. In other embodiments, the first communication node 102 may transmit the plurality of sub-MIBs such that at least two of the sub-MIBs overlap each other in both the time domain and the frequency domain.

FIG. 3B shows a flow chart of another example method 350 for wireless communication that includes receiving a plurality of sub-MIBs. The method 350 may be performed in the system 100, where one or more of the second communication nodes 104 receives the plurality of sub-MIBs from the first communication node 102. Accordingly, in various embodiments, the plurality of sub-MIBs received by the one or more second communication nodes 104 may include those that are transmitted by the first communication node 102 at block 304 of the method 300. For example, in at least some embodiments, the plurality of sub-MIBs may include any of various combinations of one or more common sub-MIBs and one or more specific sub-MIBs. In addition or alternatively, the plurality of sub-MIBs may include an N-number of sub-MIBs, where each sub-MIB includes a respective portion of a complete set of information included in a MIB.

In further detail, at block 352, a second communication node 104 receives a MIB from the first communication node 102, where the MIB comprises a plurality of sub-MIBs. At block 354, the second communication node 104 may detect the plurality of sub-MIBs upon receiving them. In various embodiments, the detecting may include detecting a presence or absence of each of the sub-MIBs, detecting a respective positions (including respective frequency positions in a frequency domain and/or time positions in a time domain) of each of the sub-MIBs, and/or detecting, identifying, and/or processing information included in each of the sub-MIBs that are received. Also, in various embodiments, the second communication node 104 may receive and/or detect the plurality of sub-MIBs according to the overlapping/non-overlapping transmission schemes in the time and frequency domains that the first communication node 102 used to transmit the plurality of sub-MIBs. In response to the detection, the second communication node 104 may use the information to connect to the wireless communication system 100 and/or further communicate with the first communication node 102 and/or any other communication node connected in the system 100.

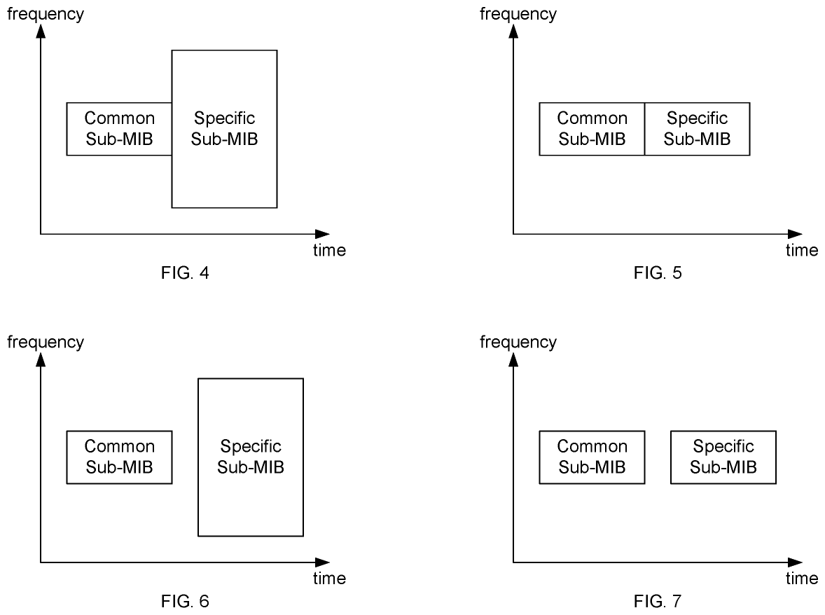

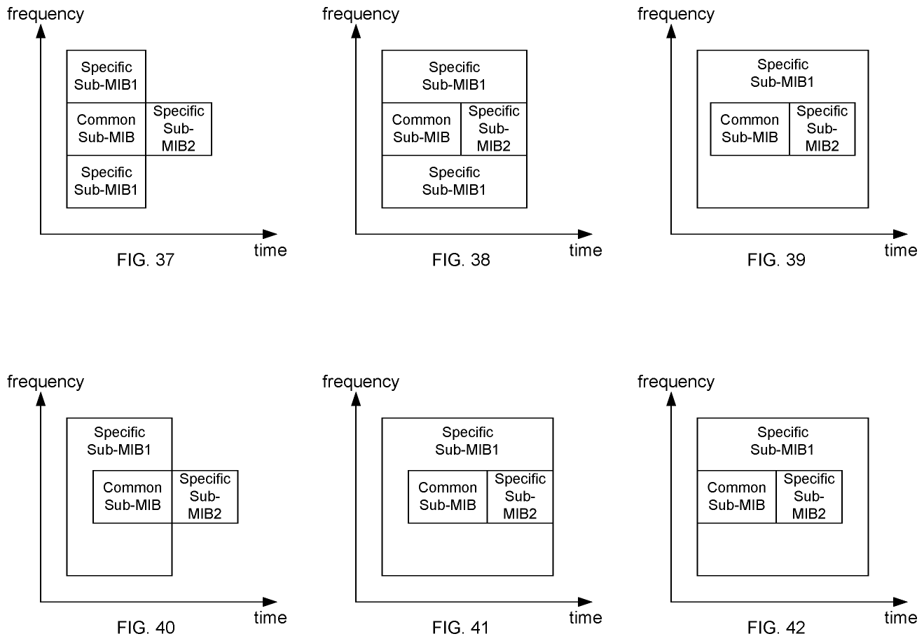

FIGS. 4-55 show time-frequency domain plots, illustrating various example, non-limiting ways the first communication node 102 may allocate resources or resource sets in the time domain and the frequency domain for transmission of a plurality of sub-MIBs to one or more of the second communication nodes 104 according to various overlapping and non-overlapping schemes, in combination with any of the various embodiments of the example 300. Correspondingly, FIGS. 4-55 show time-frequency domain plots of various example, non-limiting ways one or more of the second communication nodes 104 can receive and detect a plurality of sub-MIBs, including detection of their respective positions in the time and frequency domains and/or information included in the plurality of sub-MIBs, in accordance with the allocated time and frequency domain resources, and in combination with any of the various embodiments of the example method 350 of FIG. 3B.

The time-frequency domain plots in FIGS. 4-55 show the plurality of sub-MIBs as comprising, or configured as, at least one common sub-MIB and at least one specific sub-MIB, although in any of other various embodiments, the at least one common sub-MIB and the at least one specific sub-MIB can be more generically referred to as first sub-MIB, second sub-MIB, etc., without common and specific designations. In addition or alternatively, in any of the various time-frequency domain plots of FIGS. 4-55, positions of a common sub-MIB and a specific sub-MIB in the time and frequency domains can be interchanged with each other, and/or positions of specific sub-MIBs for different types in the time and frequency domains can be interchanged with each other.

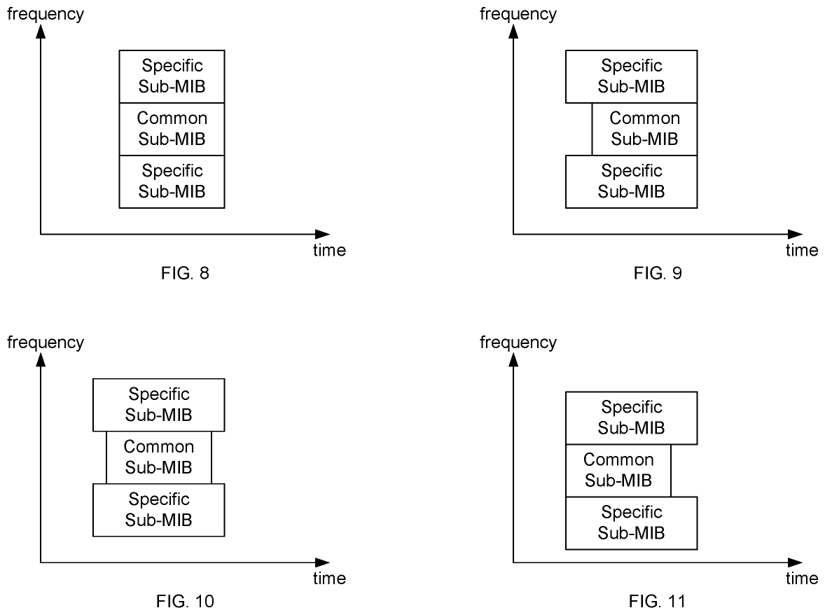

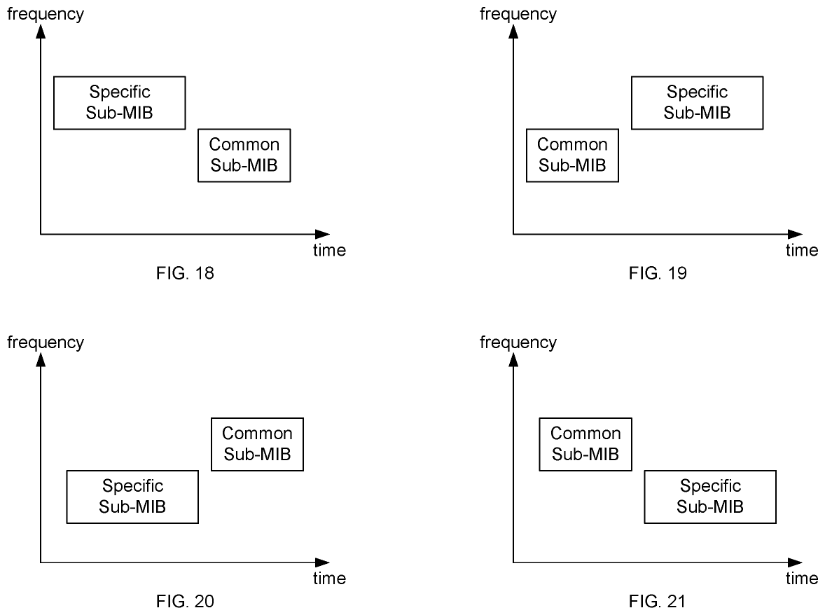

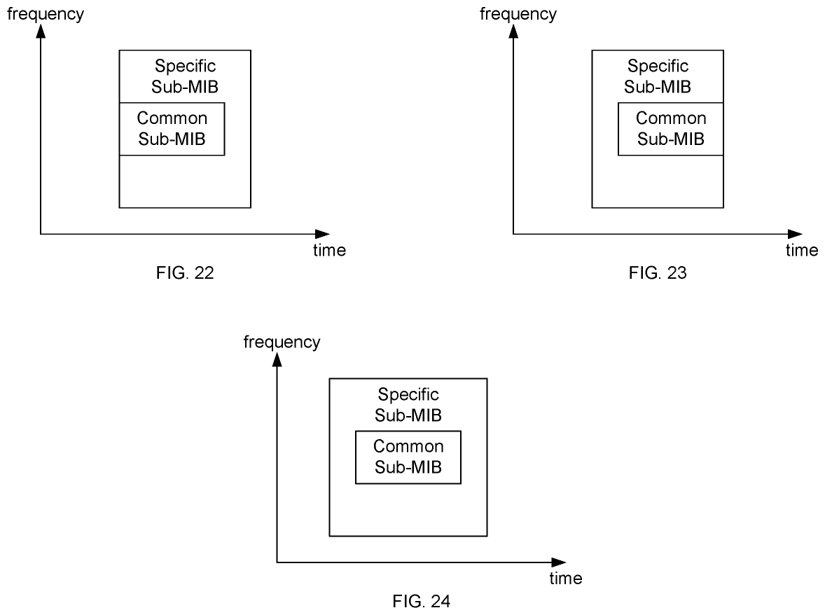

Among the various embodiments, FIGS. 4-7, and 31-55 show resource sets for the plurality of sub-MIBs, with at least two of the resource sets not overlapping in the time domain and overlapping in the frequency domain. In addition, FIGS. 8-17, 34, 37, 38, 45-50, 51, 53, 54 show at least two of the resource sets overlapping in the time domain and not overlapping in the frequency domain. Also, FIGS. 18-21, 34, 37, 46, 49, 53, 54, 55 show at least two of the resource sets not overlapping in the time domain and not overlapping in the frequency domain. Additionally, FIGS. 22-30, 35, 36, 39-42, 52-54 show at least two of the resource sets overlapping in both the time domain and the frequency domain.

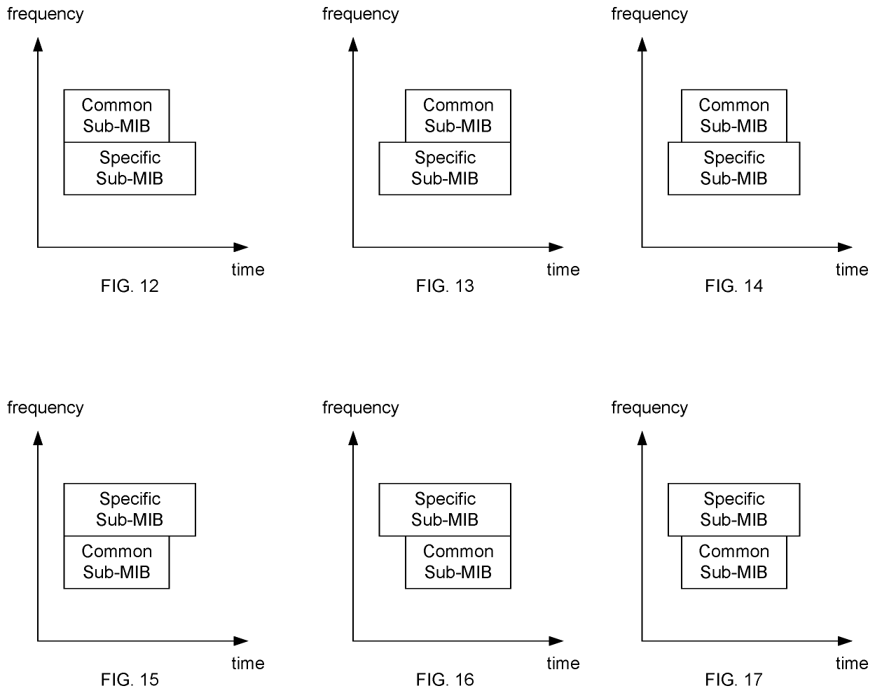

In combination with one or more of these overlapping/non-overlapping configurations, in some embodiments, at least two of the sub-MIBs may be centered around a same center frequency or frequency position, as shown in FIGS. 4-7, 22-24, 31-44, 51-55. As shown in these figures, resource sets may centered around a same center frequency or frequency position when they are mapped to respective ranges of frequency domain resources (e.g., subcarriers) that are centered around or about the same frequency resource (e.g., the same subcarrier). In addition or alternatively, at least two resource sets have different center frequencies, as shown in FIGS. 12-21, 25-30, 45-51, 53, 54, 55.

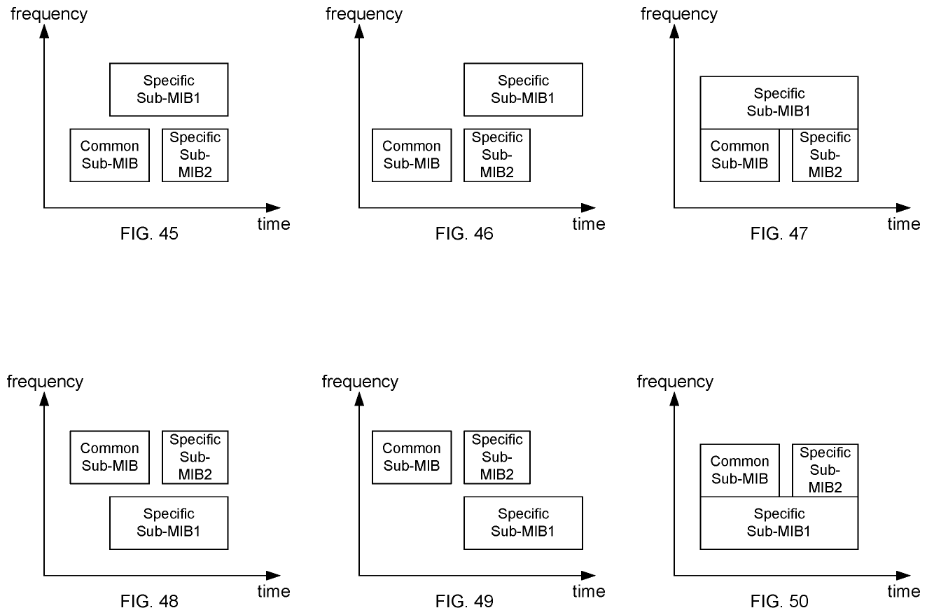

Also, in some embodiments where resource sets for a first sub-MIB and a second sub-MIB do not overlap each other in the frequency domain, a resource set for a first sub-MIB may extend over a first range of frequencies or subcarriers, and a resource set for a second sub-MIB may extend over a second range of frequencies or subcarriers, where the first range has all higher frequencies or subcarriers than the second range. In some of these embodiments, the lowest frequency of the first range and the highest frequency of the second range are separated by one or more sub-carriers in the frequency domain, such as shown in FIGS. 45, 46, 48, 49, 55. In other of these embodiments, the lowest frequency of the first range and the highest frequency of the second range are not separated by one or more sub-carriers in the frequency domain, such as shown in FIGS. 8-21, 34, 37, 38, 47, 50, 51, 53, 54. In addition or alternatively, for some of these embodiments where the two sub-MIBs include a common sub-MIB and a specific sub-MIB, the resource set for the common sub-MIB may have the first range of higher frequencies (or sub-carriers) and the resource set for the specific sub-MIB may have the second range of lower frequencies (or sub-carriers), as shown in FIGS. 12-14, 20, 21, 48-50, 54. For other of these embodiments, where the two sub-MIBs include a common sub-MIB and a specific sub-MIB, the resource set for the specific sub-MIB may have the first range of higher frequencies and the resource set for the common sub-MIB may have the second range of lower frequencies to the common sub-MIB, as shown in FIGS. 15-17-19, 45-47, 53.

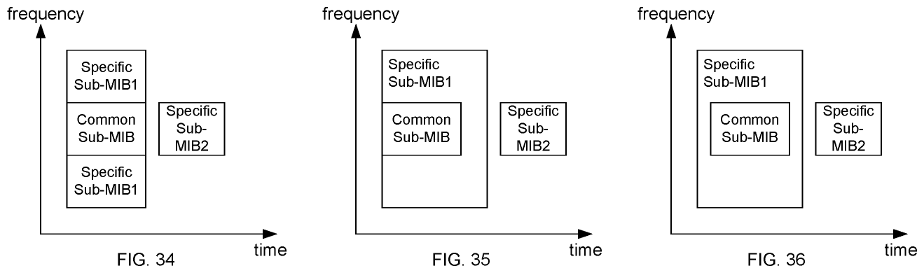

In still other embodiments, where two resource sets for two sub-MIBs do not overlap each other in the frequency domain, a resource set for the first sub-MIB may extend over a first range of frequencies or subcarriers, and a resource set for the second sub-MIB may extend over two ranges of frequencies or subcarriers, including a second range and a third range. The second range may include frequencies or subcarriers higher than those of the first range, and the third range may include frequencies or subcarriers lower than those of the first range, such as shown in FIGS. 8-11, 34, 37, 38, and 51. For at least some of these embodiments, as shown in these figures, the second and third ranges may be symmetrical about a center frequency of the first range. In addition or alternatively, in particular of these embodiments, the first sub-MIB allocated the single range is configured as a common sub-MIB, and the second sub-MIB allocated the two ranges is configured as a specific sub-MIB, as shown in FIGS. 8-11, 34, 37, 38, and 51. In addition or alternatively, for embodiments including two sub-MIBs that do not overlap in the frequency domain, the first communication node 102 may allocate only one range for each of the two sub-MIBs, as shown in FIGS. 45-50, 53, and 54, or may allocate one range for one of the sub-MIBs and two ranges for two of the sub-MIBs, as shown in FIGS. 34, 37, 38, and 51.

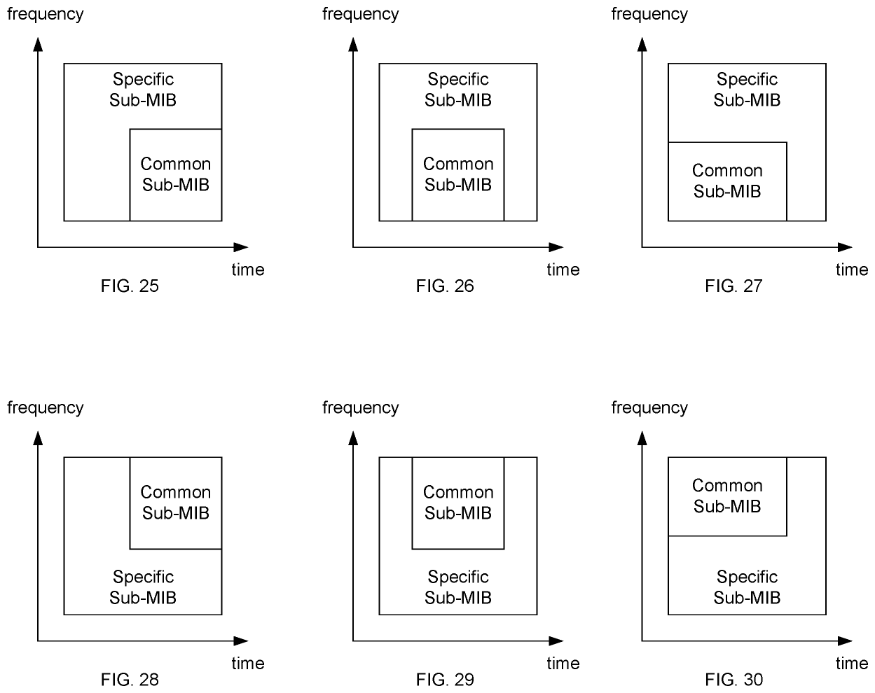

In addition or alternatively, for embodiments where two sub-MIBs overlap each other in both the time domain and the frequency domain, the two sub-MIBs may only partially overlap each other in each of the time domain and the frequency domain. Where the two sub-MIBs overlap each other in the time domain, resource sets for sub-MIBs may each extend over only one frequency range, as shown in FIGS. 25-30, or one of the sub-MIBs may have a resource set that extends over only one frequency range (a first frequency range) another of the sub-MIBs may have a resource set that extends over two frequency ranges (a second frequency range and a third frequency range), as shown in FIGS. 22-24, 35, 36, 39-42, 52-54. In general, as used herein, a frequency range may be a range of continuous frequencies extending from a lower frequency to an upper frequency. The lower frequency is, defines, or determines a lower bound of the frequency range, and the upper frequency is, defines, or determines an upper bound of the frequency range. For these latter embodiments, the second frequency range may be higher than the first frequency range and the third frequency range may be lower than the first frequency range. Also, for at least some of these embodiments as shown in these figures, for the sub-MIB that has a resource set allocated in the non-overlapping portion of the time domain, that resource set may extend over a single frequency range. The lower and higher frequencies of that single frequency range may be the same as the lower and higher frequencies of the frequency ranges over the overlapping portion in the time domain, as shown in these figures. Additionally, for at least some of these embodiments where the resource sets for the two sub-MIBs overlap in each of the time and frequency domains, the two sub-MIBs include a common sub-MIB and a specific sub-MIB, and the specific sub-MIB is the sub-MIB that is allocated resources in the non-overlapping portion (or portions) in the time domain.

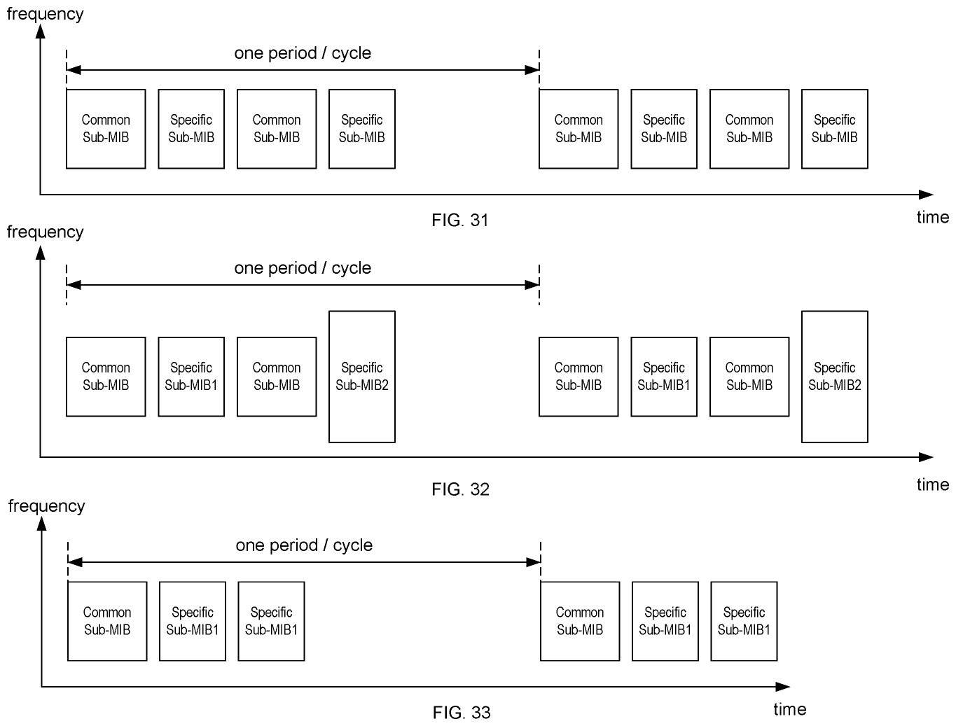

Additionally, in various embodiments, resource sets for at least two of the sub-MIBs may have the same bandwidth, such as shown in FIGS. 5, 7, 12-21, 31-54. In some of these embodiments, the two sub-MIBs allocated the same bandwidth may include a common sub-MIB and a specific sub-MIB, as shown in FIGS. 5, 7, 12-21, 31-54. In addition or alternatively, two sub-MIBs allocated the same bandwidth may include two specific sub-MIBs, as shown in FIGS. 31, 33, 45-50. In addition or alternatively, in various embodiments, at least two of the sub-MIBs may be allocated resource sets with different bandwidths, such as shown in FIGS. 4, 6, 32, 43, 44, 51-54.

Additionally, in combination with one or more of the overlapping/non-overlapping transmission schemes, in various embodiments, resource sets for two sub-MIBs may have a same start time based on a same symbol, slot, subframe, or frame in the time domain, as shown in FIGS. 8, 11, 12, 15, 22, 27, 30, 34, 35, 37, 38, 42, 46, 47, 49-51, 53, 54. In addition or alternatively, in various embodiments, resource sets for two sub-MIBs may have different start times based on different symbols, slots, subframes or frames in the time domain, as shown in FIGS. 4-7, 9, 10, 13, 14, 16-21, 23-26, 28, 29, 31-55. In addition or alternatively, in various embodiments, resource sets for two sub-MIBs may have a same end time based on a same symbol, slot, or frame in the time domain, as shown in FIGS. 8, 9, 13, 16, 23, 25, 28, 34, 37, 38, 40, 41, 45, 47, 48, 50-54. In addition or alternatively, in various embodiments, resource sets for two sub-MIBs may have different end times based on different symbols, slots, subframes or frames in the time domain, as shown in FIGS. 4-7, 10-12, 14, 15, 17-22, 24, 26, 27, 29-54. In accordance and/or in combination with any of the various combinations of the same or different start times and end times, at least two of the sub-MIBs may have time durations that are the same as each other (as shown in FIGS. 4-8, 31-34, 37, 43, 44, 51-55) or different from each other (as shown in FIGS. 9-55). Additionally, in accordance with these various combinations, a sub-MIB configured as a common sub-MIB may be allocated a time duration that is the same as, longer than, or shorter than, a time duration of a specific sub-MIB. Similarly, two sub-MIBs configured as specific sub-MIBs (either for the same time or for different types) may be allocated time durations that are the same as or different from each other, in any of various embodiments.

In addition or alternatively, resource sets for at least two sub-MIBs that do not overlap each other in the time domain, may be temporally spaced apart in the time domain from an end time of one sub-MIB to a start time of the other sub-MIB by zero symbols or slots or by a time duration less than one symbol or slot, such as shown in FIGS. 4-7, 37-42, 51-54. In addition or alternatively, resource sets for at least two sub-MIBs that do not overlap each other in the time domain may be temporally spaced apart in the time domain from an end time of one sub-MIB to a start time of the other sub-MIB by a time duration greater than or equal to one symbol or slot, such as shown in FIGS. 18-21, 31-36, and 43-55.

In addition or alternatively, in various embodiments, as illustrated in FIGS. 31-33, the first communication node 102 may periodically transmit a plurality of sub-MIBs to one or more second communication nodes 104, and/or the one or more second communication nodes 104 may periodically receive a plurality of sub-MIBs from the first communication node 102. In some embodiments, such as shown in FIGS. 31-33, by periodically transmitting, the first communication node 102 may send the same configuration of sub-MIBs and/or the one or more second communication nodes 104 may receive the same configuration of sub-MIBs, such as a same number of common sub-MIBs and the same number of specific sub-MIBs and/or with the same information, according to the same pattern (same time and frequency domain scheme) in each period or cycle, as illustrated in FIGS. 31-33. In some embodiments, as shown in FIGS. 31 and 32, in each cycle or period, the first communication node 102 may transmit, and/or the one or more second communication nodes 104 may receive, a plurality of common sub-MIBs and a plurality of specific sub-MIBs. In particular of these embodiments, as illustrated in these figures, the plurality of sub-MIBs may have a predetermined correspondence or ratio between the common sub-MIBs and the specific sub-MIBs. For example, the plurality of sub-MIBs may have has a one-to-one ratio or correspondence between the common sub-MIBs and the specific sub-MIBs (e.g., two common sub-MIBs and two specific sub-MIBs in FIGS. 31 and 32). In some of these embodiments, as shown in FIG. 31, the specific sub-MIBs may be configured for a same or common type of second communication node. In other of these embodiments, as shown in FIG. 32, the specific sub-MIBs may be configured for different types of second communication nodes (designed Sub-MIB1 and Sub-MIB2 in FIG. 32). In still other embodiments, as shown in FIG. 33, in each of the periods or cycles, the first communication node 102 transmits, and/or the one or more second communication nodes 104 receive, only one common sub-MIB and a plurality of sub-MIBs. In addition or alternatively, a ratio or correspondence between specific sub-MIBs and common sub-MIBs is greater than one-to-one. For example, as shown in FIG. 33, in each period or cycle, the first communication node 102 transmits, and/or the one or more second communication nodes 104 receive, a plurality of (e.g., two) specific sub-MIBs corresponding to a single common sub-MIB. For some of these embodiments, the multiple specific sub-MIBs may be configured for a same or common type of second communication node, as shown in FIG. 33, although the specific sub-MIBs may be configured for different types of second communication nodes in any of various other embodiments.

In other embodiments, by periodically transmitting the plurality of sub-MIBs, the first communication node 102 may not transit the same configuration of sub-MIBs in every period or cycle. In addition or alternatively, by periodically receiving the plurality of sub-MIBs, the one or more second communication nodes 104 may not receive the configuration of sub-MIBs in every period of cycle. For example, in any two or more of a plurality of periods or cycles over which the plurality of sub-MIBs are communicated, the first communication node 102 may transmit, and/or the one or more second communication nodes 104 may receive, different configurations of the plurality of sub-MIBs, such as according to different patterns (in the frequency domain and/or time domain), different numbers of the sub-MIBs, different combinations of one or more of the plurality of sub-MIBs, and/or in different numbers in different bands. In addition or alternatively, in one or more of the periods, the first communication node 102 may not transmit, and/or the one or more second communication nodes 104 may not receive, any of the plurality of sub-MIBs. As a non-limiting example illustration, in one embodiment where the plurality of sub-MIBs includes three sub-MIBs, the first communication node 102 may transmit, and/or the one or more second communication nodes 104 may receive, all three sub-MIBs according to a first pattern in one period, all three sub-MIBs according to a second pattern in a second period, only the first and third sub-MIBs according to a third pattern in a third period, only the second sub-MIB according to a third pattern in a fourth period, no sub-MIBs in a fifth period, and so on. As another non-limiting example illustration where a common sub-MIB and two specific sub-MIBs are communicated, the common sub-MIB and two specific sub-MIBs may be transmitted/received according to a first pattern in a first period, the common sub-MIB and two specific sub-MIBs may be transmitted/received according to a second pattern in a second period, only the common sub-MIB may be transmitted/received according to a third pattern in a third period, only the two specific sub-MIBs may be transmitted/received according to a fourth pattern in a fourth period, only the common sub-MIB and one of the specific sub-MIBs may be transmitted/received according to a fifth pattern in a fifth pattern, and so on. Any of various ways for the first communication node 102 to transmit, and for one or more of the second communication nodes 104 to receive, a plurality of sub-MIBs over several periods or cycles, in accordance with one or more of any of various patterns and/or in accordance with one or more of any of various combinations or permutations of the plurality of sub-MIBs may be possible.

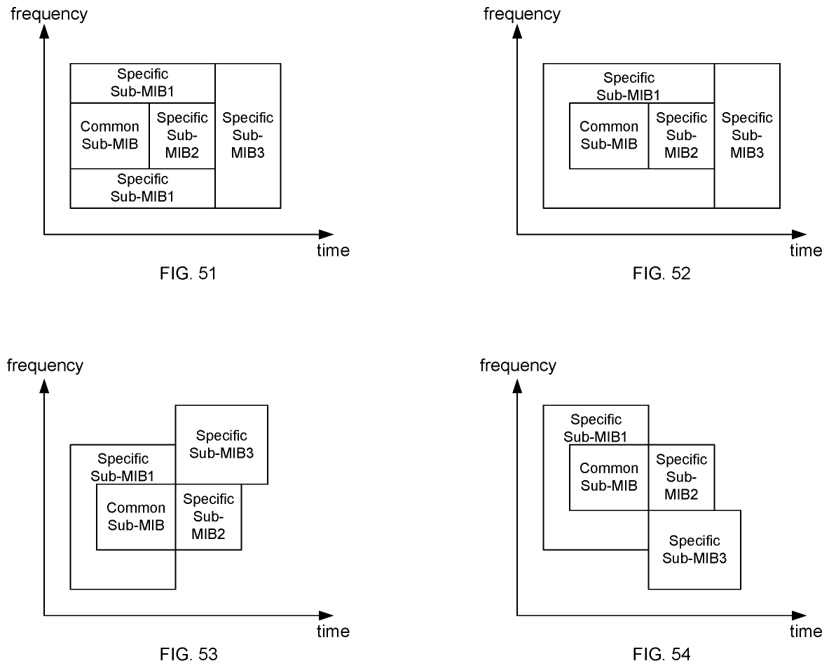

In addition or alternatively, for at least some embodiments, the plurality of sub-MIBs that a first communication node 102 transmits to at least one second communication node 104, and/or that one or more second communication nodes 104 receives, including over or in each of a plurality of cycles or periods, includes two sub-MIBs, such as only two sub-MIBs, which may include one common sub-MIB and one specific sub-MIB, as shown in FIGS. 4-30. In other embodiments, such as shown in FIGS. 31-54, the first communication node 102 may transmit, and/or the one or more second communication nodes 104 may receive, such as in a single period or cycle, or over or in each of a plurality of periods or cycles, more than two (three or more) sub-MIBs. In particular examples of these embodiments, the three or more sub-MIBs includes at least one common sub-MIB and two or more specific sub-MIBs. FIGS. 31-33 show some examples of these embodiments, as previously described. FIGS. 34-54 show other example embodiments where the number of sub-MIBs is three or more. For at least some of these other examples that includes three or more sub-MIBs, the plurality of sub-MIBs includes only one sub-MIB configured as a common sub-MIB, and a plurality of different sub-MIBs configured for different types of second communication nodes, such as illustrated in FIGS. 34-54. For example, the embodiments shown in FIGS. 34-50 each include two specific sub-MIBs, each for a different type of second communication node 104, designated as Specific sub-MIB1 and Specific sub-MIB2. The embodiment shown in FIGS. 51-54 show three specific sub-MIBs, each for a different type of second communication node 104, designated as Specific sub-MIB1, Specific sub-MIB2, and Specific sub-MIB3.

The first communication node 102 may transmit the plurality of sub-MIBs, and/or one or more second communication nodes 104 may receive and detect the plurality of sub-MIBs, for these embodiments according to any of the various time and frequency transmission schemes, as previously described. For example, the common sub-MIB may have or be allocated a first resource set, a first specific sub-MIB may have or be allocated a second resource set, and a second specific sub-MIB may have or be allocated a third resource set.

In various embodiments, the first resource set and the second resource set do not overlap each other in a time domain, and the first resource set and the third resource set overlap each other in the time domain, such as shown in FIGS. 34-42, 45, 47, 48, 50-54. In some of these embodiments, the first resource set and the second resource set overlap each other in the frequency domain, such as shown in those figures. In addition or alternatively, the first resource set and the third resource set do not overlap each other in the frequency domain, as shown in FIGS. 34, 37, 38, 45, 47, 48, 50, 51. In addition or alternatively, the third resource set has at least one of an earlier start time or a later end time than the first resource set, as shown in FIGS. 35, 36, 38-42, 45, 47, 48, 50-54. In addition or alternatively, the second resource set has a start time occurring after at least one of an end time of the first resource set or an end time of the second resource set, as shown in FIGS. 34-42, 45-54. In particular of these embodiments, the start time of the second resource set occurs after both the end time of the first resource set and the end time of the third resource set, as shown in FIGS. 34-37, 40. For other embodiments, the third resource set overlaps the second resource set in the time domain, as shown in FIGS. 38, 39, 41, 42, 45-54.

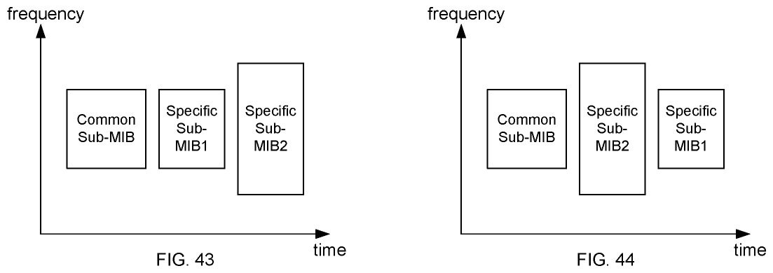

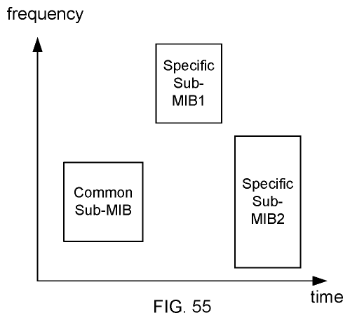

In various other embodiments, the first resource set, the second resource set, and the third resource set have a same center frequency, as shown in FIGS. 43, 44, 51, 52. In addition or alternatively, in various embodiments, the first resource set, the second resource set, and the third resource set do not overlap each other in a time domain, as shown in FIGS. 43, 44, 51, 55. In some of these embodiments, the first resource set, the second resource set, and the third resource set overlap each other in a frequency domain, as shown in FIGS. 43, 44, 51, 52. For at least some of these embodiments, the first resource set, the second resource set, and the third resource set have a same center frequency, such as shown in these figures. In other of these embodiments, only two of the first resource set, the second resource set, and the third resource set overlap each other in a frequency domain, as shown in FIG. 55.

In addition or alternatively, in various embodiments, the third resource set has a bandwidth that is larger than a bandwidth of a first resource set for the common sub-MIB, such as shown in FIGS. 35, 36, 39-42, 51-54. In addition or alternatively, the second resource set has a bandwidth that is not less than a bandwidth of the first resource set, such as shown in FIGS. 34-55. In addition or alternatively, the third resource set has a bandwidth that is not larger than a bandwidth of the second resource set, such as shown in FIGS. 45-50.

In addition or alternatively, in various embodiments, a sub-MIB configured as a common sub-MIB may have a minimum bandwidth among the plurality of sub-MIBs, such as shown in FIGS. 4, 6, 22-30, or have a bandwidth that is larger than bandwidths of any of the specific sub-MIBs (none of the specific sub-MIBs have a bandwidth smaller than a bandwidth of the common sub-MIB), such as shown in FIGS. 4-55. Also, in any of various embodiments, the bandwidths for the specific sub-MIBs are configurable. Accordingly, in any of various embodiments, two specific sub-MIBs may have the same bandwidth or different bandwidths as each other.

In addition or alternatively, in various embodiments, one of the plurality of sub-MIBs may indicate, or include information indicating, at least one of: at least a part of a system frame number (SFN). In some embodiments, only a part of the system frame number is indicated. In some embodiments, the at least a part of the system frame number may be indicated as an X-number of bits, such as 10 bits for example. In other embodiments, the at least a part of the system frame number may be indicated by an X-number of most significant bits (MSB) or least significant bits (LSB). In addition or alternatively, in some embodiments, the sub-MIB indicating the at least a part of the system frame number may be configured or designated as the common sub-MIB, although one or more sub-MIBs configured as a specific sub-MIB may indicate at least a part of a system frame number in any of various embodiments.

In addition or alternatively, one of the sub-MIBs, such as a sub-MIB configured as a common sub-MIB, may indicate a SSB-subcarrier offset (indicating a frequency position of the SSB) and/or a referred frequency position (indicating a referred frequency point position), which may be indicated in the sub-MIB by an X-number of bits, such as four bits for example. In addition or alternatively, one of the sub-MIBs, such as a sub-MIB configured as a common sub-MIB, may indicate scalable SSB information, such as in the form of an X-number of bits. The scalable SSB information may indicate a number of the plurality of sub-MIBs, a number of RATs, a number of different types of second communication nodes (e.g., UEs) 104, or a number of different application scenarios. Also, in various embodiments, a sub-MIB, such as one configured as a common sub-MIB, may indicate a SSB index, a half frame, and/or cell barred information.

In addition or alternatively, in various embodiments, a sub-MIB, such as one configured as a common sub-MIB, may indicate information, such as by including an indication, related to other of the plurality of sub-MIBs, such as whether one or more other sub-MIBs are present or were received (e.g., present and/or received in a period in which the sub-MIB including the indication was received), a number of other sub-MIBs, one or more resource positions in the time domain and/or the frequency domain of the other sub-MIBs, and/or one or more functions of the other sub-MIBs. In addition or alternatively, a sub-MIB may indicate a total number of the plurality of sub-MIBs. Accordingly, upon receipt of a first sub-MIB with the indication, the second communication node 104 may determine whether to detect a second sub-MIB, and/or may detect a position of a second sub-MIB, including at least one of a frequency position or a time position of the second sub-MIB. In a particular embodiment, the sub-MIB configured as a common sub-MIB indicates information related to the specific sub-MIBs and/or a total number of the plurality of sub-MIBs.

In addition or alternatively, one of the sub-MIBs, such as a sub-MIB configured as a common sub-MIB in various embodiments, may indicate a pattern of the plurality of sub-MIBs, or a pattern of at least a portion of the plurality of sub-MIBs (e.g., a pattern of less than all of the plurality of sub-MIBs, such as for only the specific sub-MIBs as a non-limiting example). A pattern for an associated set of sub-MIBs may indicate the positions of each of the associated set of sub-MIBs. In general, a position of a sub-MIB includes information that identifies the sub-MIB's general position in the time domain and/or the frequency domain. For the time domain, the position information may indicate periodicity information and/or a start time, as non-limiting examples. Upon receiving a plurality of sub-MIBs and identifying a pattern, a second communication node 104 may be configured to detect any or each of the sub-MIBs that it received. In addition or alternatively, one of the sub-MIBs may indicate a periodicity configuration of the sub-MIBs. The periodicity configuration may indicate information related to periodic transmission of the plurality of sub-MIBs. In addition or alternatively, one of the sub-MIBs, such as but not limited to a sub-MIB configured as a common sub-MIB in various embodiments, may indicate a sub-MIB configuration for the plurality of sub-MIBs or for at least a portion of the plurality of sub-MIBs (e.g., a sub-MIB configuration of less than all of the plurality of sub-MIBs, such as for only the specific sub-MIBs, as a non-limiting example). In various embodiments, a pattern and a sub-MIB configuration may be the same or otherwise indicate the same information. In other of various embodiments, one of the sub-MIB configuration and the pattern may indicate other or additional information that the other does not. For example, a pattern for the plurality of sub-MIBs may indicate time and frequency domain positions of the plurality of sub-MIBs, and a sub-MIB configuration for the plurality of sub-MIBs may indicate the pattern, and further indicate a starting position for the plurality of sub-MIBs, periodicity information for the plurality of sub-MIBs, other resource allocation information for the plurality of sub-MIBs, and/or other or additional information that informs, indicates, instructs, and/or notifies the first communication node 102 how to transmit the plurality of sub-MIBs and/or the one or more second communication nodes 104 how to receive the plurality of sub-MIBs, including but not limited to periodically transmitting and/or receiving the plurality of sub-MIBs over a plurality of periods or cycles.

In addition or alternatively, in various embodiments, the plurality of sub-MIBs may include three sub-MIBs, including a first sub-MIB, a second sub-MIB, and a third sub-MIB. The first sub-MIB may indicate at least one of: at least a part of a system frame number, cell bar information, or a sub-MIB configuration indicating positions of the plurality of sub-MIBs. The second sub-MIB may indicate access information. Access information may include at least a part of information for a physical random access channel (PRACH) procedure. The third sub-MIB may indicate at least one of: paging information or system information (SI) change information. In addition or alternatively, in various embodiments, the first sub-MIB may indicate at least one of the following: a part of information corresponding to a master information block (MIB) and at least a part of information corresponding to system information block 1 (SIB1), the second sub-MIB may indicate at least one of the following: a part of information corresponding to a MIB, at least a part of information corresponding to SIB1, and other system information, and a third sub-MIB may indicate at least one of the following: a part of information corresponding to SIB1 and other system information.

In addition or alternatively, in some embodiments, a common sub-MIB may indicate information about all of the plurality of sub-MIBs. For example, a common sub-MIB may include one bit to indicate whether the plurality of sub-MIBs includes only one sub-MIB or two sub-MIBs. In particular of these embodiments, a bit value indicating the plurality includes two sub-MIBs may further indicate that the position of the specific sub-MIBs is fixed. In other embodiments, the common sub-MIB may include one or two bits, each bit corresponding to a respective one of two sub-MIBs. The bit value of each bit may indicate whether a corresponding sub-MIB is included in the plurality. In still other embodiments, the common sub-MIB may include three bits, each corresponding to a respective one of three sub-MIBs. The bit value of each bit may indicate whether a corresponding sub-MIB is included in the plurality. For these latter two embodiments, the bit values may be included in the common sub-MIB according to a bitmap scheme. For example, a two-bit value “10” may indicate that a first sub-MIB is present in the plurality and a second sub-MIB is not present in the plurality. As another example, a three-bit value of “101” may indicate that a first sub-MIB is present, a second sub-MIB is not present, and a third sub-MIB is present in the plurality.

In other embodiments, a common sub-MIB may indicate information about other sub-MIBs, such as information about the specific sub-MIBs, but not information about the common sub-MIB. For example, a common sub-MIB may include one bit that indicates whether the plurality includes a specific sub-MIB. Other embodiments may include a plurality of bits, such as two bits or three bits, each corresponding to a respective one of a plurality of specific sub-MIBs and indicating whether the corresponding specific sub-MIB is present in the plurality. For example, a two-bit value of “10” may indicate that a first specific sub-MIB is present and a second specific sub-MIB is not present in the plurality. As another example, a bit value of “001” may indicate that first and second specific sub-MIBs are not present, and a third specific sub-MIB is present in the plurality.

In addition or alternatively, a common sub-MIB may include a multi-bit value to indicate whether a particular specific sub-MIB exists, and if so, which of a plurality of possible resource positions is allocated to the particular specific sub-MIB to allow a receiving second communication node 104 to detect the specific sub-MIB. As a non-limiting example, a first two-bit value (e.g., “00”) may indicate that an associated specific sub-MIB is not present in the plurality; a second two-bit value (e.g., “01”) may indicate that the associated specific sub-MIB is present in the plurality and has resources allocated in a first of three possible positions; a third two-bit value (e.g., “10”) may indicate that the associated specific sub-MIB is present in the plurality and has resources allocated in a second of the three possible positions; and a fourth two-bit value (e.g., “11”) may indicate that the associated specific sub-MIB is present in the plurality and has resources allocated in a third of the three possible positions. As another non-limiting example, a common sub-MIB may include a three-bit value, where the bit value of one of the bits indicates a position, and the other two bits indicates which of two possible specific sub-MIBs are present in the plurality. From the three-bit value, a receiving second communication node 104 may identify which of the two specific sub-MIBs are present and the position(s) of the present sub-MIBs.

In addition or alternatively, a sub-MIB of a plurality of sub-MIBs may indicate a periodicity configuration of the plurality of sub-MIBs. In general, the periodicity configuration indicates how the first communication node 102 periodically transmits the plurality of sub-MIBs, and/or how a second communication node 104 may periodically receive or detect the plurality of sub-MIBs. In some embodiments, the periodicity configuration indicates a pattern according to which the first communication node 102 allocates resources for the plurality of sub-MIBs in each of a plurality of periods or cycles. In addition or alternatively, the periodicity configuration indicates that a Y-number of specific sub-MIBs are present for every X-number of common sub-MIBs in each of the cycles or periods, where X and Y are positive integers. In addition or alternatively, a sub-MIB, including a common sub-MIB or a specific sub-MIB, may indicate control information for a physical downlink control channel (PDCCH), including at least one of the CORESET, search space, or sub-carrier spacing (SCS). In addition or alternatively, different specific sub-MIBs may be configured for different RATs, different UE types, different types of system information (e.g., initial information, access information), different idle and connected mode information, different synchronization information, different network access information, or any of various combinations thereof.

The description and accompanying drawings above provide specific example embodiments and implementations. The described subject matter may, however, be embodied in a variety of different forms and, therefore, covered or claimed subject matter is intended to be construed as not being limited to any example embodiments set forth herein. A reasonably broad scope for claimed or covered subject matter is intended. Among other things, for example, subject matter may be embodied as methods, devices, components, systems, or non-transitory computer-readable media for storing computer codes. Accordingly, embodiments may, for example, take the form of hardware, software, firmware, storage media or any combination thereof. For example, the method embodiments described above may be implemented by components, devices, or systems including memory and processors by executing computer codes stored in the memory.

Throughout the specification and claims, terms may have nuanced meanings suggested or implied in context beyond an explicitly stated meaning. Likewise, the phrase “in one embodiment/implementation” as used herein does not necessarily refer to the same embodiment and the phrase “in another embodiment/implementation” as used herein does not necessarily refer to a different embodiment. It is intended, for example, that claimed subject matter includes combinations of example embodiments in whole or in part.

In general, terminology may be understood at least in part from usage in context. For example, terms, such as “and”, “or”, or “and/or,” as used herein may include a variety of meanings that may depend at least in part on the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

Reference throughout this specification to features, advantages, or similar language does not imply that all of the features and advantages that may be realized with the present solution should be or are included in any single implementation thereof. Rather, language referring to the features and advantages is understood to mean that a specific feature, advantage, or characteristic described in connection with an embodiment is included in at least one embodiment of the present solution. Thus, discussions of the features and advantages, and similar language, throughout the specification may, but do not necessarily, refer to the same embodiment.

Furthermore, the described features, advantages and characteristics of the present solution may be combined in any suitable manner in one or more embodiments. One of ordinary skill in the relevant art will recognize, in light of the description herein, that the present solution can be practiced without one or more of the specific features or advantages of a particular embodiment. In other instances, additional features and advantages may be recognized in certain embodiments that may not be present in all embodiments of the present solution.

1. A method of wireless communication, the method comprising:
determining, with a first communication node, a master information block (MIB) to transmit to a second communication node, wherein the MIB comprises a plurality of sub-MIBs; and
transmitting, with the first communication node, the plurality of sub-MIBs to the second communication node.

2. (canceled)

3. The method of claim 1, wherein the plurality of sub-MIBs comprises a common sub-MIB and a specific sub-MIB, wherein the common sub-MIB comprises first information common for communication nodes of different types, and wherein the specific sub-MIB comprises second information particular for a specific type of the second communication node.

4. The method of claim 1, wherein one of the sub-MIBs indicates at least one of: at least a part of a system frame number; a number of types of sub-MIBs; a number of types of specific sub-MIBs; a frequency position of a synchronization signal block; or a configuration of the specific sub-MIB indicating at least one of a frequency domain position of the specific sub-MIB or a time domain position of the specific sub-MIB.

5. The method of claim 1, wherein one of the sub-MIBs indicates a pattern of the plurality of sub-MIBs, wherein the pattern indicates position of the plurality of sub-MIBs.

6. The method of claim 1, wherein one of the sub-MIBs indicates a periodicity configuration of the plurality of sub-MIBs.

7. The method of claim 1, wherein the plurality of sub-MIBs comprises a first sub-MIB that comprises at least part of a system frame number, cell bar information, or a sub-MIB configuration indicating at least one of frequency domain positions or time domain positions of the plurality of sub-MIBs.

8. The method of claim 1, wherein the plurality of sub-MIBs comprises a second sub-MIB that comprises access information.

9. (canceled)

10. The method of claim 1, wherein resource sets for at least two of the plurality of sub-MIBs:
do not overlap in a time domain and overlap in a frequency domain;
overlap in a time domain and do not overlap in a frequency domain
do not overlap in a time domain and do not overlap in a frequency domain;
overlap in a time domain and overlap in a frequency domain; or
are centered about a same center frequency or have a same center frequency.

11-14. (canceled)

15. The method of claim 1, wherein a first resource set for a first sub-MIB extends over a first frequency range, and a second resource set extends for a second sub-MIB extends over a second frequency range and a third frequency range, and wherein at least one of:
the second frequency range is higher than the first frequency range, and the third frequency range is lower than the first frequency range, or
the second frequency range and the third frequency range are symmetrical about a center frequency of the first frequency range

16. (canceled)

17. The method of claim 1, wherein resource sets for at least two of the plurality of sub-MIB at least one of:
have at least one of a same start time or a same end time based on a symbol, a slot, subframe, or a frame;
have a same time duration;
are separated in a time domain by an offset, where the offset is greater than or equal to 0 slot or symbol;
have a same bandwidth;
have at least one of a same lower frequency or a same upper frequency; or
are separated in a frequency domain by an offset, where the offset no less than 0 subcarrier or resource block or a bandwidth.

18-22. (canceled)

23. The method of claim 1, wherein the plurality of sub-MIBs comprises a common sub-MIB, a first specific sub-MIB for a first type of communication node and a second specific sub-MIB for a second type of communication node.

24. The method of claim 23, wherein:
a first resource set for the common sub-MIB and a second resource set for the first specific sub-MIB do not overlap each other in a time domain, and wherein the first resource set and a third resource set for the second specific sub-MIB overlap each other in the time domain,
the first resource set and the second resource set overlap each other in the frequency domain,
the first resource set and the third resource set do not overlap each other in the frequency domain,
the third resource set has an earlier start time than the first resource set,
the third resource has a later end time than the first resource set,
the third resource set and the first resource set have a same start time,
the third resource set and the first resource set have a same end time, or
the second resource set has a start time occurring after at least one of an end time of the first resource set or an end time of the third resource set.

25-29. (canceled)

30. The method of claim 23, wherein a first resource set for the common sub-MIB, a second resource set for the first specific sub-MIB, and the third resource set for the second specific sub-MIB have a same center frequency.

31. The method of claim 23, wherein a first resource set for the common sub-MIB, a second resource set for the first specific sub-MIB, and a third resource set for the second specific sub-MIB do not overlap each other in a time domain.

32. The method of claim 31, wherein:
the first resource set for the common sub-MIB, the second resource set for the first specific sub-MIB, and the third resource set for the second specific sub-MIB overlap each other in a frequency domain,
only two of the first resource set, the second resource set, and the third resource set overlap each other in a frequency domain, or
the first resource set, the second resource set, and the third resource set have a same center frequency.

33-34. (canceled)

35. The method of claim 23, wherein:
a third resource set for the second specific sub-MIB has a bandwidth that is larger than a bandwidth of a first resource set for the common sub-MIB, or
a second resource set for the first specific sub-MIB has a bandwidth that is not less than a bandwidth of a first resource set for the common sub-MIB; or
the third resource set for the second specific sub-MIB has a bandwidth that is not larger than a bandwidth of the second resource set for the first specific sub-MIB.

36-37. (canceled)

38. The method of claim 23, wherein the plurality of specific sub-MIBs further comprises a third specific sub-MIB for a third type of communication node.

39-41. (canceled)

42. A wireless communications apparatus comprising:
a memory storing a plurality of instructions; and
a processor configured to execute the plurality of instructions, and upon execution of the plurality of instructions, is configured to:
determine a master information block (MIB) to transmit, wherein the MIB comprises a plurality of sub-MIBs; and
transmit the plurality of sub-MIBs.

43. (canceled)

44. A method of wireless communication, the method comprising:
receiving, with a second communication node, a master information block (MIB) from a first communication node, the MIB comprising a plurality of sub-MIBs; and
detecting, with the second communication node, the plurality of sub-MIBs upon receiving the plurality of sub-MIBs.

45. The method of claim 44, wherein detecting the plurality of sub-MIBs comprises:
detecting, with the second communication node, a second sub-MIB of the plurality of sub-MIBs based on an indication in a first sub-MIB of the plurality of sub-MIBs.
